(19) United States
(12) Patent Application Publication
(10) Pub. No.: US 2023/0342443 A1
(43) Pub. Date: Oct. 26, 2023

(54) SERVER DEVICE, SYSTEM, METHOD FOR CONTROLLING SERVER DEVICE, AND STORAGE MEDIUM

(71) Applicant: NEC Corporation, Minato-ku, Tokyo (JP)

(72) Inventors: Takumi Otani, Tokyo (JP); Takeshi Sasamoto, Tokyo (JP); Junichi Inoue, Tokyo (JP)

(73) Assignee: NEC Corporation, Minato-ku, Tokyo (JP)

(21) Appl. No.: 18/024,914

(22) PCT Filed: Sep. 11, 2020
(86) PCT No.: PCT/JP2020/034520

§ 371 Date: Mar. 6, 2023

(51) Int. Cl. G06F 21/32

(52) U.S. Cl. CPC G06F 21/32

(57) ABSTRACT

A server device includes a reception unit, an authentication unit, a storage unit, and a generating unit. The reception unit receives an authentication request including biometric information of a person to be authenticated, from a terminal that has acquired the biometric information of the person to be authenticated, out of a plurality of terminals. The authentication unit performs biometric authentication using the biometric information of the person to be authenticated, and biometric information of each of a plurality of users registered in advance. With regard to an authentication-successful person for which biometric authentication is successful, the storage unit stores the biometric information registered in advance and detailed information of authentication results in a correlated manner. The detailed information of authentication results includes biometric information acquired by the terminal that is the transmission source of the authentication request.

### TECHNICAL FIELD

The present invention relates to a server device, a system, a method for controlling the server device, and a storage medium.

### BACKGROUND ART

Entrance/exit examinations are conducted at airports, ports, and the like. The duty officer in charge of the entrance/exit examination compares the face photograph affixed to the passport with the face of the person in front of the duty officer, and permits the person to enter or leave the country when the face image of the passport matches the face of the person in front of the duty officer.

There has been developed a technique related to the use of biometric authentication for the entrance/exit examination procedure.

For example, a movement monitoring method described in PTL 1 acquires biometric data and associated identity confirmation data of an individual at a first point on a movement path of a person from a public area to a secure area. The movement monitoring method acquires biometric data and associated identity confirmation data of an individual at a second point in the secure area. In the movement monitoring method, the identity confirmation data acquired at the second point is compared with the identity confirmation data acquired at the second point. Further, when there is consistency, the movement monitoring method compares the related image acquired at the first point with the related image acquired at the second point for the consistent identity confirmation data.

PTL 2 describes providing a technique capable of estimating an effect of an accuracy improvement measure in advance and presenting the effect to an administrator.

### CITATION LIST

### Patent Literature

[PTL 1] JP 2007-506159 A
[PTL 2] JP 2014-081796 A

### SUMMARY OF INVENTION

### Technical Problem

As disclosed in PTL 1 and 2, various technologies related to biometric authentication have been developed. However, the accuracy of biometric authentication is limited, and a certain ratio of false authentication (acceptance of another person, rejection of the subject person) may occur. When a false authentication occurs in a procedure at an airport, it takes time to correct the false authentication, or the user leaves for a foreign country while boarding a wrong airplane.

A main object of the present invention is to provide a server device, a system, a method for controlling the server device, and a storage medium that contribute to enabling detection of occurrence of false authentication (in particular, acceptance of another person) in biometric authentication.

### Solution to Problem

According to a first aspect of the present invention, provided is a server device including a reception unit that receives, from a terminal that has acquired biometric information about a person to be authenticated among a plurality of terminals, an authentication request including biometric information about the person to be authenticated, an authentication unit that performs biometric authentication using biometric information about the person to be authenticated and biometric information about each of a plurality of users registered in advance, and a storage unit that stores, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

According to a second aspect of the present invention, provided is a system including a plurality of terminals, and a server device connected to the plurality of terminals, wherein the server device includes a reception unit that receives, from a terminal that has acquired biometric information about a person to be authenticated among a plurality of terminals, an authentication request including biometric information about the person to be authenticated, an authentication unit that performs biometric authentication using biometric information about the person to be authenticated and biometric information about each of a plurality of users registered in advance, and a storage unit that stores, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

According to a third aspect of the present invention, provided is a method for controlling a server device, the method including, by the server device, receiving, from a terminal that has acquired biometric information about a person to be authenticated among a plurality of terminals, an authentication request including biometric information about the person to be authenticated, performing biometric authentication using biometric information about the person to be authenticated and biometric information about each of a plurality of users registered in advance, and storing, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

According to a fourth aspect of the present invention, provided is a computer-readable storage medium storing a program for causing a computer mounted on a server device to execute processing including receiving, from a terminal that has acquired biometric information about a person to be authenticated among a plurality of terminals, an authentication request including biometric information about the person to be authenticated, a step of performing biometric authentication using biometric information about the person to be authenticated and biometric information about each of a plurality of users registered in advance, and a step of storing, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

### Advantageous Effects of Invention

According to each aspect of the present invention, there are provided a server device, a system, a method for controlling a server device, and a storage medium that contribute to enabling detection of occurrence of false authentication (in particular, acceptance of another person) in biometric authentication. The effect of the present invention is not limited to the above. According to the present invention, other effects may be exhibited instead of or in addition to the effect.

### BRIEF DESCRIPTION OF DRAWINGS

FIG. 1 is a diagram for describing an outline of an example embodiment.

FIG. 2 is a diagram illustrating an example of a schematic configuration of a boarding procedure system according to the first example embodiment.

FIG. 3 is a diagram illustrating an example of a processing configuration of a check-in terminal according to the first example embodiment.

FIG. 4 is a diagram for explaining an operation of a system registration unit according to the first example embodiment.

FIG. 5 is a diagram illustrating an example of a processing configuration of the system registration unit according to the first example embodiment.

FIG. 6 is a diagram illustrating an example of a processing configuration of a boarding gate device according to the first example embodiment.

FIG. 7 is a diagram illustrating an example of an authentication request according to the first example embodiment.

FIG. 8 is a diagram illustrating an example of a processing configuration of a server device according to the first example embodiment.

FIG. 9 is a diagram illustrating an example of a token ID information database according to the first example embodiment.

FIG. 10 is a diagram illustrating an example of an operation information database according to the first example embodiment.

FIG. 11 is a diagram illustrating an example of an authentication result database according to the first example embodiment.

FIG. 12 is a diagram for explaining the operation of a verification information generation unit according to the first example embodiment.

FIG. 13 is a diagram for explaining the operation of the verification information generation unit according to the first example embodiment.

FIG. 14 is a sequence diagram illustrating an example of an operation of the boarding procedure system according to the first example embodiment.

FIG. 15 is a diagram for explaining an operation of a verification information generation unit according to the second example embodiment.

FIG. 16 is a diagram illustrating an example of a hardware configuration of a server device.

FIG. 17 is a diagram for describing an operation of a server device according to a modification of the present disclosure.

FIG. 18 is a diagram for explaining an operation of a staff terminal according to the modification of the present disclosure.

FIG. 19 is a diagram for explaining an operation of a staff terminal according to the modification of the present disclosure.

FIG. 20 is a diagram for explaining an operation of a staff terminal according to the modification of the present disclosure.

FIG. 21 is a diagram illustrating an example of a processing configuration of a server device according to the modification of the disclosure of the present application.

### EXAMPLE EMBODIMENT

First, an outline of an example embodiment will be described. The reference numerals in the drawings attached to this outline are attached to each of elements for convenience as an example for assisting understanding, and the description of this outline is not intended to be any limitation. Unless there is a specific reason to the contrary, the block described in each drawing represents not a configuration of a hardware unit but a configuration of a functional unit. Connection lines between blocks in each drawing include both bidirectional and unidirectional lines. The unidirectional arrow schematically indicates a flow of a main signal (data), and does not exclude bidirectionality. In the present specification and the drawings, elements that can be similarly described are denoted by the same reference numerals, and redundant description can be omitted.

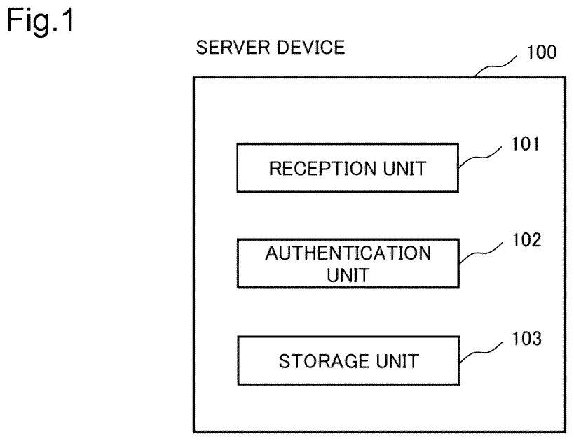

A server device 100 according to the example embodiment includes a reception unit 101, an authentication unit 102, and a storage unit 103 (see FIG. 1). The reception unit 101 receives, from a terminal that has acquired biometric information about a person to be authenticated among a plurality of terminals, an authentication request including biometric information about the person to be authenticated. The authentication unit 102 performs biometric authentication using the biometric information about the person to be authenticated and biometric information about each of a plurality of users registered in advance. With regard to an authentication-successful person for which biometric authentication is successful, the storage unit 103 stores the biometric information registered in advance and authentication result detailed information in association with each other. The authentication result detailed information includes biometric information acquired by the terminal that is the transmission source of the authentication request.

Each time the authentication request from the terminal is processed, the server device 100 stores details of the result (history). By using the history information, the server device 100 can generate authentication result verification information for a staff member of an airport or the like to verify whether an authentication result includes a false authentication (in particular, false authentication related to acceptance of another person). The information is provided to the staff or the like, and the staff member can detect the occurrence of acceptance of another person by checking the display generated based on the information. Here, the authentication result verification information can include the ID of the terminal that has acquired the acquired face image in addition to the two types of biometric information (for example, the registered face image and the acquired face image) used for authentication. Since the staff or the like can identify the terminal in which the false authentication has occurred based on the ID of the terminal, it is possible to quickly solve the problem and contradiction caused by the occurrence of the acceptance of another person.

Hereinafter, specific example embodiments will be described in more detail with reference to the drawings.

### First Example Embodiment

The first example embodiment will be described in more detail with reference to the drawings.

### Configuration of System

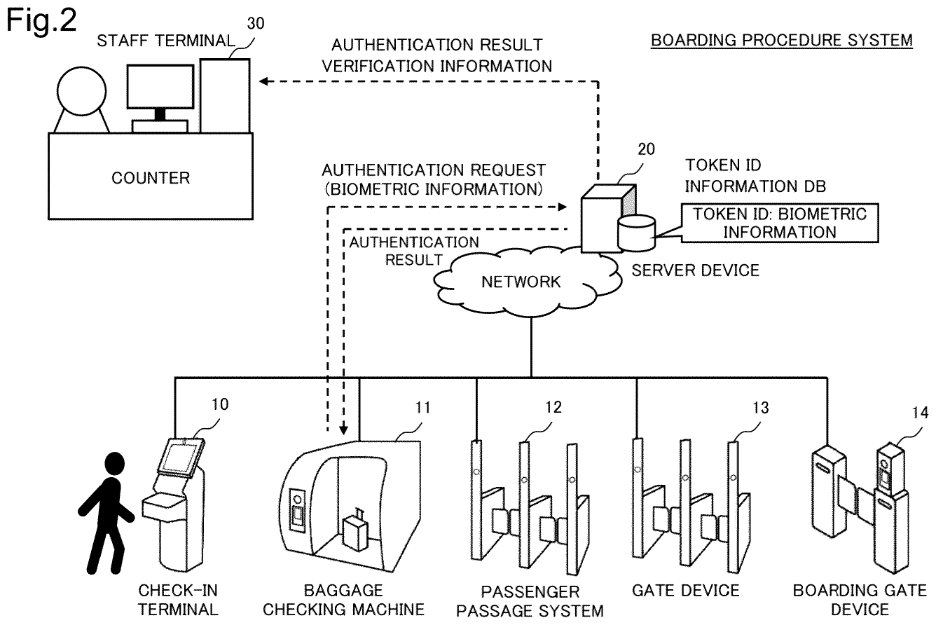

FIG. 2 is a diagram illustrating an example of a schematic configuration of a boarding procedure system according to the first example embodiment. The boarding procedure system according to the first example embodiment is a system that achieves a series of procedures (deposit of baggage, security check, etc.) at an airport by biometric authentication. The boarding procedure system illustrated in FIG. 2 is operated by, for example, a public institution such as a control station for immigration or emigration, or a trustee that is entrust with the job from the public institution.

In the present disclosure, the “boarding procedure” indicates a series of procedures performed from check-in to boarding of the aircraft.

Referring to FIG. 2, the boarding procedure system includes a check-in terminal 10, a baggage checking machine 11, a passenger passage system 12, a gate device 13, a boarding gate device 14, a server device 20, and a staff terminal 30.

The check-in terminal 10, the baggage checking machine 11, the passenger passage system 12, the gate device 13, and the boarding gate device 14 are terminals (touch points) installed at the airport. These terminals are connected to the server device 20 via a network. The network illustrated in FIG. 2 includes a local area network (LAN) including an airport local communication network, a wide area network (WAN), a mobile communication network, and the like. The connection method is not limited to the wired method, and may be a wireless method.

The server device 20 is installed in a facility such as an airport company. Alternatively, the server device 20 may be a server installed in a cloud on a network.

The staff terminal 30 is a terminal used by the staff or the like of an airport or an airline company. The boarding procedure system may include one staff terminal 30 or a plurality of staff terminals 30.

The staff terminal 30 may be a stationary computer as illustrated in FIG. 2, or may be a portable terminal such as a mobile phone, a smartphone, a tablet, or a notebook computer. The staff terminal 30 may have any type or form as long as it is a terminal used by the staff.

The configuration illustrated in FIG. 2 is an example and is not intended to limit the configuration of the boarding procedure system. The boarding procedure system may include a device (not illustrated) or the like.

The boarding procedure of the user is performed by each terminal illustrated in FIG. 2. Specifically, a series of procedures when the user leaves the country is sequentially performed by terminals installed at five places. In the boarding procedure system illustrated in FIG. 2, the boarding procedure of the user is achieved by authentication (biometric authentication) using biometric information.

The biometric information in the present disclosure is a face image, a fingerprint image, an iris image, a finger vein image, a palm print image, a palm vein image, or the like. Alternatively, the biometric information may be voice data (voiceprint) in which human voice is stored. The biometric information may be one or a plurality of pieces of biometric information. The term “biometric information” in the disclosure of the present application means image data including all or part of a living body, voice data, and a feature amount extracted from the image.

When arriving at the airport, the user (system user) who desires a boarding procedure by biometric authentication operates the check-in terminal 10 to perform the “check-in procedure”. The system user presents a paper airline ticket, a two-dimensional barcode describing boarding information, a mobile terminal displaying a copy of an e-ticket, and the like to the check-in terminal 10. Upon completion of the check-in procedure, the check-in terminal 10 outputs a boarding pass. The boarding pass includes a boarding pass of a paper medium and a boarding pass of an electronic medium.

The system user who has completed the check-in procedure and desires a boarding procedure by biometric authentication performs system registration using the check-in terminal 10. Specifically, the system user causes the check-in terminal 10 to read the acquired boarding pass and the passport. The check-in terminal 10 acquires biometric information (for example, a face image) of the system user.

The check-in terminal 10 transmits information about these (boarding pass, passport, biometric information) to the server device 20.

The server device 20 confirms the validity of the information acquired from the check-in terminal 10. Specifically, server device 20 confirms the validity of the presented passport. Upon completion of the confirmation, the server device 20 registers the system user. Specifically, the server device 20 issues a token used for the boarding procedure of the user registered in the system.

The issued token is identified by a token identifier (ID). Information (for example, biometric information, operation information necessary for boarding procedures, and the like) necessary for the boarding procedure is associated with the token ID. That is, the “token” is issued together with the registration of the system user, and is identification information for the registered system user to receive the boarding procedure using the biometric information. When the token (token ID) is issued, the system user can use a boarding procedure using biometric authentication.

In response to the generation of the token, the server device 20 adds an entry to each of the token ID information database and the operation information database.

The token ID information database is a database that stores detailed information about the generated token. The database stores at least the token ID and the biometric information (Face image, feature amount) in association with each other. The server device 20 performs biometric authentication with reference to the token ID information database.

The operation information database is a database that stores operation information. The operation information database stores the token ID and the operation information in association with each other. The operation information is information required when the terminal proceeds with a procedure (operation).

When the system user to which the token is issued arrives at the terminal, the biometric information (for example, a face image) is acquired by the terminal. The terminal transmits an authentication request including the face image to the server device 20.

In the present disclosure, when described as a “terminal”, it means an apparatus, a device, or the like that transmits an authentication request including biometric information to the server device 20. In the example of FIG. 2, the baggage checking machine 11, the passenger passage system 12, the gate device 13, and the boarding gate device 14 correspond to “terminals”. Alternatively, in a case where the check-in procedure is also performed by the biometric authentication, the check-in terminal 10 also corresponds to the “terminal”.

The server device 20 performs biometric authentication using the biometric information acquired from the terminal and the biometric information registered in the system. When the biometric authentication succeeds, the server device 20 transmits an acknowledgment indicating the success to the terminal. The acknowledgment includes operation information necessary for the terminal to proceed with the procedure. When the biometric authentication fails, the server device 20 transmits a negative acknowledgment indicating the failure to the terminal.

The server device 20 stores and manages detailed information when the authentication request received from each terminal is processed. Specifically, the server device 20 stores the details and the like using the authentication result database. Details of the authentication result database will be described later.

The terminal that has received the authentication success performs the boarding procedure of the user based on the acquired operation information. For example, the terminal opens a gate or the like as necessary to allow the user to pass. The terminal that has received the authentication failure notifies the person to be authenticated of the fact.

The server device 20 analyzes a result of the authentication process (detailed information) stored in the authentication result database, and generates authentication result verification information for the staff or the like of an airport or an airline company verifying whether the result of the biometric authentication includes a false authentication (in particular, false authentication concerning acceptance of another person). The server device 20 provides the generated authentication result verification information to the staff terminal 30.

The staff verifies whether the acceptance of another person occurs based on the display generated based on the authentication result verification information. When the acceptance of another person occurs, the staff member resolves contradiction or the like caused by the occurrence of the acceptance of another person.

Next, a schematic configuration, a function, and the like of each device will be described.

The check-in terminal 10 is installed in a check-in lobby in the airport. As described above, the user performs system registration for achieving the boarding procedure using the biometric authentication using the check-in terminal 10. The system user performs a check-in procedure by operating the check-in terminal 10. That is, the check-in terminal 10 is a self-terminal for performing a check-in procedure by being operated by the user. The check-in terminal 10 is also referred to as a common use self service (CUSS) terminal. After completing the check-in procedure, the user moves to the baggage checking area or the security check area.

The baggage checking machine 11 is installed in an area adjacent to a baggage counter (manned counter) or an area near the check-in terminal 10 in the airport. The baggage checking machine 11 is a self-terminal for performing a procedure (baggage checking procedure) of checking baggage that is not brought into the aircraft by being operated by a user. The baggage checking machine 11 is also referred to as a common use bag drop (CUBD) terminal. After completing the baggage checking procedure, the user moves to the security check area. In a case where the user does not check baggage, the baggage checking procedure is omitted.

The passenger passage system 12 is a gate device installed at an entrance of a security check area in an airport. The passenger passage system 12 is also referred to as a passenger reconciliation system (PRS), and is a system that determines whether a user can pass at an entrance of a security check area. When the user completes the security inspection procedure after passing through the passenger passage system 12, the user moves to the departure examination site.

The gate device 13 is installed in a departure examination site in the airport. The gate device 13 is a device that automatically performs a departure examination procedure of the user. After completing the departure examination procedure, the user moves to the departure area where the duty-free shop and the boarding gate are provided.

The boarding gate device 14 is a passage control device installed for each boarding gate in the departure area. The boarding gate device 14 is a final stage gate device in a series of procedures of the departure examination (examination using biometric information). The boarding gate device 14 is also referred to as an automated boarding gates (ABG) terminal. The boarding gate device 14 confirms that the user is a passenger of the aircraft that the user board from the boarding gate. After passing through the boarding gate device 14, the user boards the aircraft and leaves for the second country.

The boarding procedure using biometric authentication by each device (check-in terminal 10, baggage checking machine 11, passenger passage system 12, gate device 13, boarding gate device 14) illustrated in FIG. 2 is an example, and is not intended to limit the device used for the procedure. For example, a device different from the above devices may be used for the boarding procedure, or some of the above devices may not be used for the procedure. For example, the gate device 13 may not be included in the boarding procedure system.

The server device 20 is a server device for supporting and managing the boarding procedure. The server device 20 manages the token ID. Specifically, the server device 20 issues or invalidates the token ID. The server device 20 processes authentication requests from various terminals in the airport.

Next, details of each device included in the boarding procedure system according to the first example embodiment will be described. In the following description, a “face image” or a “feature amount generated from the face image” of the user will be described as an example of the biometric information.

[Check-In Terminal]

As described above, the check-in terminal 10 is a device that provides the system user with an operation related to the check-in procedure and the system registration.

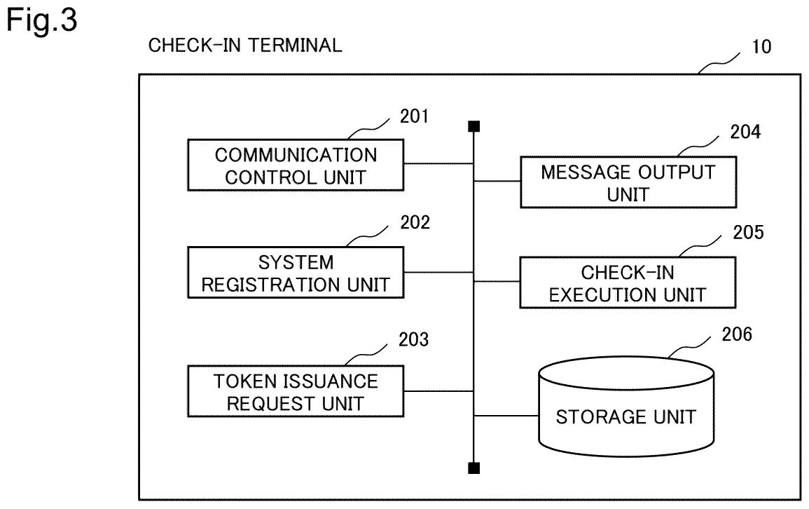

FIG. 3 is a diagram illustrating an example of a processing configuration (processing module) of the check-in terminal 10 according to the first example embodiment. Referring to FIG. 3, the check-in terminal 10 includes a communication control unit 201, a system registration unit 202, a token issuance request unit 203, a message output unit 204, a check-in execution unit 205, and a storage unit 206.

The communication control unit 201 is a means configured to control communication with other devices. For example, the communication control unit 201 receives data (packet) from the server device 20. The communication control unit 201 transmits data to the server device 20. The communication control unit 201 delivers data received from another device to another processing module. The communication control unit 201 transmits data acquired from another processing module to another device. In this manner, the other processing modules transmit and receive data to and from other devices via the communication control unit 201.

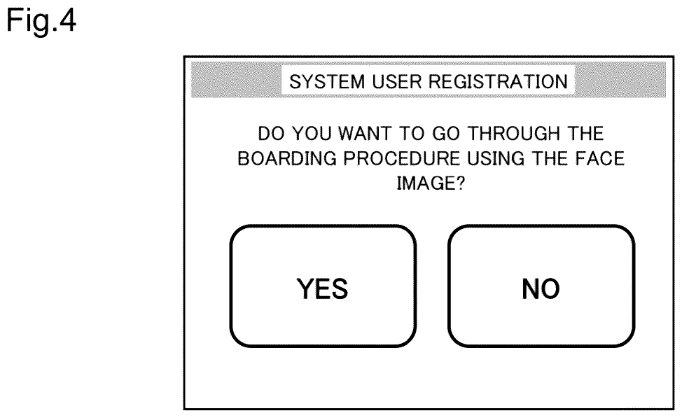

The system registration unit 202 is a means configured to perform system registration of a user who desires the boarding procedure by biometric authentication. For example, after the completion of the check-in procedure, the system registration unit 202 provides the user with a graphical user interface (GUI) for checking whether the user desires the “boarding procedure using the face image” (see FIG. 4).

When the user desires to perform the boarding procedure using the face image, the system registration unit 202 acquires three pieces of information (information described in the boarding pass, information described in the passport, and biometric information) using the GUI.

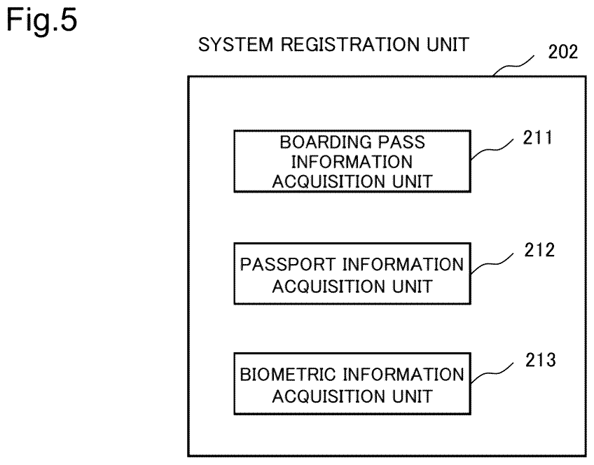

The system registration unit 202 includes three submodules. FIG. 5 is a diagram illustrating an example of a processing configuration (processing module) of the system registration unit 202 according to the first example embodiment. As illustrated in FIG. 5, system registration unit 202 includes a boarding pass information acquisition unit 211, a passport information acquisition unit 212, and a biometric information acquisition unit 213.

The boarding pass information acquisition unit 211 is a means configured to acquire information (hereinafter, referred to as boarding pass information) described in a boarding pass owned by the system user. The boarding pass information acquisition unit 211 controls a reader (not illustrated) such as a scanner to acquire boarding pass information.

The boarding pass information includes a name (family name, first name), an airline code, a flight number, a boarding date, a departure place (boarding airport), a destination (arrival airport), a seat number, a boarding time, an arrival time, and the like.

The passport information acquisition unit 212 is a means configured to acquire information (hereinafter, described as passport information) described in the passport possessed by the system user. The passport information acquisition unit 212 controls a reader such as a scanner to acquire the passport information.

The passport information includes a face image (hereinafter, referred to as a passport face image), a name, a gender, a nationality, a passport number, a passport issuing country, and the like.

The biometric information acquisition unit 213 is a means configured to acquire biometric information about the system user. The biometric information acquisition unit 213 controls the camera to acquire the face image of the system user. For example, when detecting the face in an image that is constantly or periodically captured, the biometric information acquisition unit 213 captures the face of the user and acquires the face image.

It is desirable that the biometric information acquisition unit 213 display a guidance message regarding capturing of the face image via the message output unit 204 before capturing the face image. For example, the biometric information acquisition unit 213 displays a message such as “We will capture a face image of you and register it in the system. The registered face image will be deleted from the system after the boarding is completed”.

The system registration unit 202 delivers the acquired three pieces of information (boarding pass information, passport information, and biometric information) to the token issuance request unit 203.

The token issuance request unit 203 illustrated in FIG. 3 is a means configured to request the server device 20 to issue a token. The token issuance request unit 203 generates a token issuance request including the boarding pass information, the passport information, and the biometric information (face image). The token issuance request unit 203 transmits the generated token issuance request to the server device 20.

The token issuance request unit 203 delivers the response (response to the token issuance request) acquired from the server device 20 to the message output unit 204.

The message output unit 204 is a means configured to output various messages. For example, the message output unit 204 outputs a message related to the response acquired from the server device 20.

In a case where a response (acknowledgment) indicating that the token has been successfully issued is received, the message output unit 204 outputs the fact. For example, the message output unit 204 outputs a message such as “The future procedure can be performed by face authentication”.

In a case where a response (negative acknowledgment) indicating that the issue of the token has failed is received, the message output unit 204 outputs the fact. For example, the message output unit 204 outputs a message such as “Sorry, the face authentication procedure cannot be performed. Please head to the manned booth”.

The check-in execution unit 205 is a means configured to perform a check-in procedure of the user. The check-in execution unit 205 executes a check-in procedure such as selection of a seat based on the airline ticket presented by the user. For example, the check-in execution unit 205 transmits the information described in the airline ticket to a departure control system (DCS) and acquires the information described in the boarding pass from the DCS. The operation of the check-in execution unit 205 can be the same as the operation of the existing check-in terminal, and thus a more detailed description will be omitted.

The storage unit 206 is a means configured to store information necessary for the operation of the check-in terminal 10.

[Boarding Gate Device]

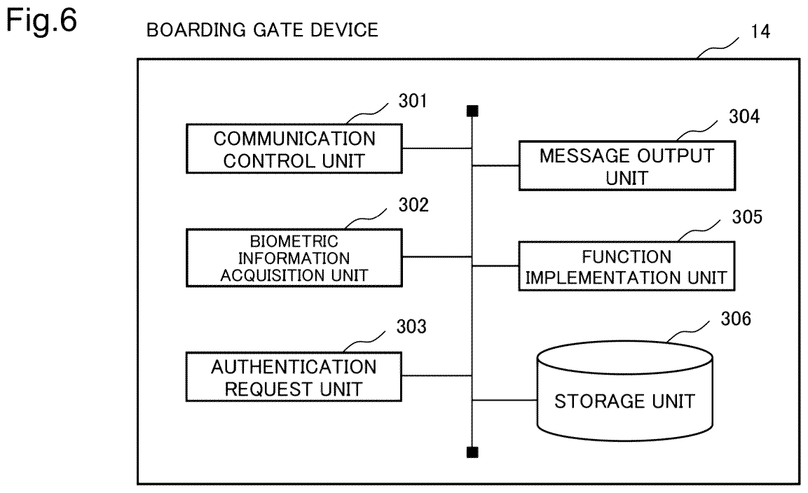

FIG. 6 is a diagram illustrating an example of a processing configuration (processing module) of the boarding gate device 14 according to the first example embodiment. Referring to FIG. 6, the boarding gate device 14 includes a communication control unit 301, a biometric information acquisition unit 302, an authentication request unit 303, a message output unit 304, a function implementation unit 305, and a storage unit 306.

The communication control unit 301 is a means configured to control communication with other devices. For example, the communication control unit 301 receives data (packet) from the server device 20. The communication control unit 301 transmits data to the server device 20. The communication control unit 301 delivers data received from another device to another processing module. The communication control unit 301 transmits data acquired from another processing module to another device. In this manner, the other processing modules transmit and receive data to and from other devices via the communication control unit 301.

The biometric information acquisition unit 302 is a means configured to control a camera (not illustrated) to acquire biometric information about the user. The biometric information acquisition unit 302 captures an image ahead of the gate device periodically or at predetermined timing. The biometric information acquisition unit 302 determines whether a face image of a person is included in the acquired image, and extracts the face image from the acquired image data in a case where the face image is included.

Since an existing technology can be used for the face image detection processing and the face image extraction processing by the biometric information acquisition unit 302, detailed description thereof will be omitted. For example, the biometric information acquisition unit 302 may extract a face image (face region) from the image data by using a learning model learned by a convolutional neural network (CNN). Alternatively, the biometric information acquisition unit 302 may extract the face image using a method such as template matching.

The biometric information acquisition unit 302 delivers the extracted face image to the authentication request unit 303.

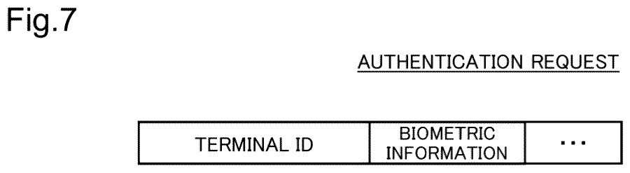

The authentication request unit 303 is a means configured to request the server device 20 to authenticate the user in front of the gate device. The authentication request unit 303 generates an authentication request including an identifier (hereinafter, referred to as a terminal ID) of the gate device, the acquired face image, and the like (see FIG. 7). As the terminal ID, a media access control (MAC) address, an Internet protocol (IP) address, or the like can be used. The authentication request unit 303 transmits the generated authentication request to the server device 20.

The server device 20 can uniquely identify the terminal that is the transmission source of the authentication request by checking the terminal ID included in the authentication request. The server device 20 can also identify the type of terminal (baggage checking machine 11, passenger passage system 12, gate device 13, boarding gate device 14) based on the terminal ID. The terminal ID is shared between each terminal and the server device 20 included in the system. For example, a system administrator or the like may determine a terminal ID and input the determined terminal ID to each terminal. The system administrator may input table information or the like in which the terminal ID and the type of the terminal are associated with each other to the server device 20.

The authentication request unit 303 receives a response to the authentication request from the server device 20. The authentication request unit 303 delivers the response acquired from the server device 20 to the message output unit 304 and the function implementation unit 305.

The message output unit 304 is a means configured to output various messages. For example, the message output unit 304 outputs a message related to the authentication result (authentication success, authentication failure) acquired from the server device 20.

The function implementation unit 305 is a means configured to implement the function of the boarding gate device 14. The function implementation unit 305 implements a procedure related to an authentication-successful person (a person to be authenticated determined to be successfully authenticated). The function implementation unit 305 identifies the flight number of the aircraft that the user (authentication-successful person) can board from the acquired operation information. The function implementation unit 305 permits the authentication-successful person to pass through the gate when the identified flight number matches the flight number assigned to the gate device. The operation of the function implementation unit 305 can be the same as the operation of the existing boarding gate device, and thus a detailed description thereof will be omitted. The staff working in the airline of the aircraft that the user board from the boarding gate device 14 may assign (input) the necessary flight number to the boarding gate device 14.

In a case where the authentication-successful person is permitted to pass through the gate, the function implementation unit 305 notifies the server device 20 of the permission.

The storage unit 306 is a means configured to store information necessary for the operation of the boarding gate device 14.

[Other Terminals]

A basic processing configuration of other terminals (baggage checking machine 11, passenger passage system 12, and gate device 13) included in the boarding procedure system can be the same as the processing configuration of the boarding gate device 14 illustrated in FIG. 6, and thus a detailed description thereof will be omitted. Each terminal acquires biometric information (face image) of the system user and requests the server device 20 to perform authentication using the acquired biometric information. When the authentication succeeds, the function allocated to each terminal is executed. Each terminal outputs a display (message) related to the authentication result (authentication success, authentication failure).

[Server Device]

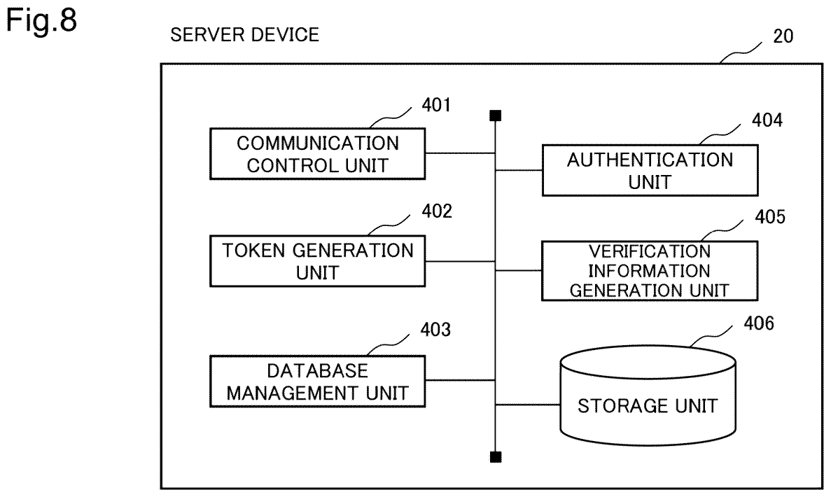

FIG. 8 is a diagram illustrating an example of a processing configuration (processing module) of the server device 20 according to the first example embodiment. Referring to FIG. 8, the server device 20 includes a communication control unit 401, a token generation unit 402, a database management unit 403, an authentication unit 404, a verification information generation unit 405, and a storage unit 406.

The communication control unit 401 is a means configured to control communication with other devices. For example, the communication control unit 401 receives data (packet) from the check-in terminal 10. The communication control unit 401 transmits data to the check-in terminal 10. The communication control unit 401 delivers data received from another device to another processing module. The communication control unit 401 transmits data acquired from another processing module to another device. In this manner, the other processing modules transmit and receive data to and from other devices via the communication control unit 401. The communication control unit 401 has a function as an “acquisition unit” that acquires the biometric information about the person to be authenticated from the terminal. Alternatively, the communication control unit 401 has functions as a “reception unit” that receives an authentication request including biometric information about the person to be authenticated and a “transmission unit” that transmits a response to the authentication request.

The token generation unit 402 is a means configured to generate a token in response to a token generation request from the check-in terminal 10. At this time, the token generation unit 402 makes a determination related to validity of the passport presented by the user.

Specifically, the token generation unit 402 determines whether a person who presents the passport to the check-in terminal 10 and a person who has received the issuance of the passport are the same person. In order to make the determination, the token generation unit 402 extracts the face image (the face image of the system user) included in the token generation request and the passport face image included in the passport information. The token generation unit 402 determines whether the two face images substantially match.

The token generation unit 402 executes collation (one-to-one collation) of the two face images. The token generation unit 402 calculates a feature vector from each of the two images. The token generation unit 402 calculates the similarity (for example, Euclidean distance) between the two images, and determines whether the two images are face images of the same person based on a result of threshold value process on the calculated similarity. For example, in a case where the similarity is larger than a predetermined value (in a case where the distance is shorter than the predetermined value), the token generation unit 402 determines that the two face images are of the same person.

When the validity determination of the passport using the biometric information is successful, the token generation unit 402 issues the token. For example, the token generation unit 402 generates a unique value as the token ID based on the date and time, the sequence number, and the like at the time of processing.

When generating the token (token ID), the token generation unit 402 transmits an acknowledgment (token issuance) to the check-in terminal 10. When failing to generate the token ID, the token generation unit 402 transmits a negative acknowledgment (no token issuance) to the check-in terminal 10.

When the token ID is successfully generated (issued), the token generation unit 402 delivers the generated token ID, boarding pass information, passport information, and face image (face image of the system user) to the database management unit 403.

The database management unit 403 is a means (management unit) configured to manage the database constructed in the server device 20.

The server device 20 includes a token ID information database, an operation information database, and an authentication result database.

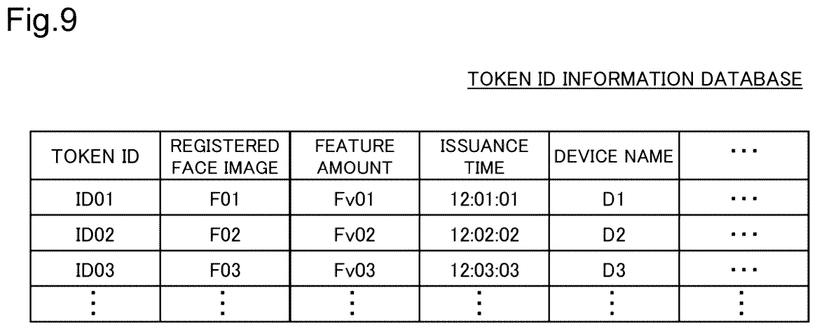

The token ID information database stores at least the token ID and the biometric information about the user in association with each other. FIG. 9 is a diagram illustrating an example of a token ID information database. Referring to FIG. 9, the token ID information database has fields for storing a token ID, a registered face image, a feature amount, a token issuance time, a token issuance device name, and the like.

As described above, the token ID is an identifier that is temporarily issued. When the user finishes the procedure in the boarding gate device 14, the token ID is invalidated. That is, the token ID is not an identifier that is permanently used, but is a one-time ID having a valid period (life cycle).

The registered face image is a face image of a system user. For example, the registered face image may be a face image of the user captured by the check-in terminal 10, or may be a passport face image. The feature amount is a feature vector generated from the face image. The token issuance time is a time when the server device 20 issues the token ID. The device name is a device name (for example, the check-in terminal 10) of an acquisition source of the registered face image that has triggered issuance of the token ID.

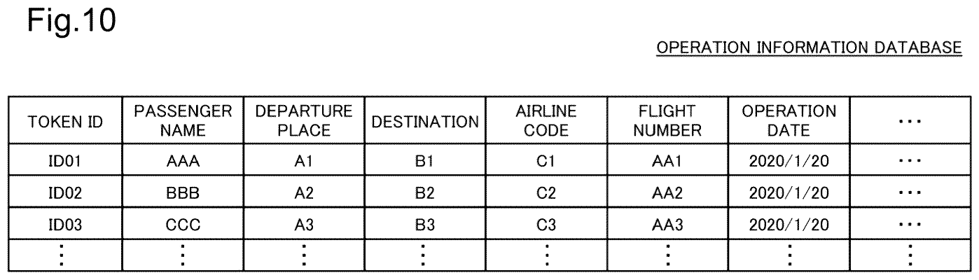

The operation information database is a database that manages information (operation information) necessary for the boarding procedure of the user. FIG. 10 is a diagram illustrating an example of the operation information database. Referring to FIG. 10, the operation information database has fields for storing a token ID, a passenger name, a departure place, a destination, an airline code, a flight number, an operation date, and the like. In addition to the above fields, the operation information database may include fields for storing a seat number, a nationality, a passport number, a family name, a first name, a date of birth, a gender, and the like. The operation information database stores operation information necessary for predetermined operation (procedure operation performed at each touch point) for each token ID.

The information stored in the operation information database is acquired from the boarding pass information and the passport information.

When acquiring the token ID from the token generation unit 402 (when the token ID is issued), the database management unit 403 adds a new entry to the two databases. The database management unit 403 sets a setting value in a field of each database. For example, the database management unit 403 generates a feature amount from the registered face image and registers the generated feature amount in the token ID information database. The database management unit 403 may set initial values (default values) for a field for which a setting value cannot be set.

The authentication unit 404 is a means configured to perform biometric authentication. The authentication unit 404 processes the authentication request acquired from the terminal. The authentication unit 404 performs biometric authentication using biometric information about the person to be authenticated and biometric information about each of a plurality of users registered in advance in the token ID information database.

Specifically, the authentication unit 404 processes the authentication request from the terminal that has acquired the biometric information about the person to be authenticated among the plurality of terminals with reference to the token ID information database. The authentication request includes biometric information about the person to be authenticated. The authentication unit 404 executes a collation process (one-to-N collation) using the biometric information included in the authentication request and the biometric information registered in the token ID information database.

The authentication unit 404 generates a feature amount from a face image acquired from a terminal (baggage checking machine 11, passenger passage system 12, gate device 13, boarding gate device 14). An existing technique can be used for the feature amount generation process, and thus a detailed description thereof will be omitted. For example, the authentication unit 404 extracts eyes, a nose, a mouth, and the like as feature points from the face image. Thereafter, the authentication unit 404 calculates the position of each feature point and the distance between the feature points as feature amounts, and generates a feature vector including a plurality of feature amounts.

The authentication unit 404 sets the generated feature amount (feature vector) as the feature amount on the collation side and sets the feature amounts stored in the token ID information database as the feature amounts on the registration side.

The authentication unit 404 calculates the similarity (score) between the feature amount on the collation side and each of the plurality of feature amounts on the registration side. A chi-square distance, a Euclidean distance, or the like can be used as the similarity. The similarity is lower, the distance is longer, and the similarity is higher, the distance is shorter.

The authentication unit 404 determines that the authentication is successful when there is a feature amount whose similarity with the feature amount of the collation target is equal to or more than a predetermined value among the plurality of feature amounts (valid feature amounts) registered in the token ID information database.

When the authentication succeeds, the authentication unit 404 identifies the token ID related to the feature amount having the highest similarity. The authentication unit 404 searches the operation information database using the identified token ID as a key, and identifies a related entry.

The authentication unit 404 transmits the authentication result to the terminal (responds to the authentication request).

When the authentication is successful, the authentication unit 404 transmits an acknowledgment including the entry (token ID, operation information) identified from the operation information database to the terminal.

When the authentication fails, the authentication unit 404 transmits a negative acknowledgment indicating the authentication failure to the terminal.

Next, the authentication result database will be described. As described above, the detailed information when the authentication request from each terminal is processed is stored in the authentication result database. The authentication result database stores biometric information registered in advance for the authentication-successful person who has succeeded in the biometric authentication and information (hereinafter, it is referred to as authentication result detailed information) including details when the authentication request is processed in association with each other.

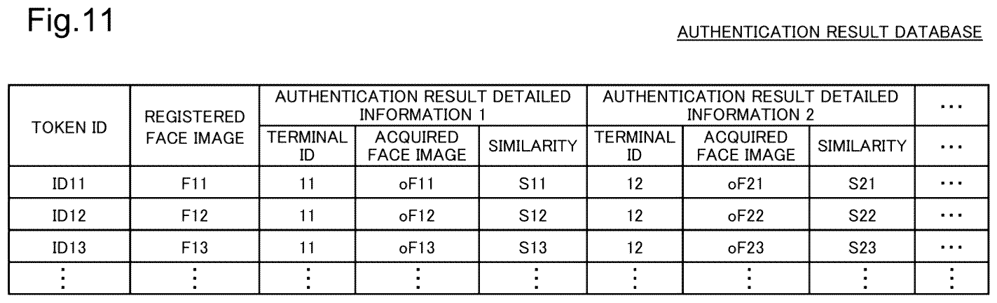

FIG. 11 is a diagram illustrating an example of an authentication result database. As illustrated in FIG. 11, the authentication result database stores the registered face image and at least one or more pieces of authentication result detailed information for each token ID (for each authentication-successful person). The authentication result detailed information includes a terminal ID for identifying a transmission source of the authentication request, an acquired face image (face image acquired by the terminal) included in the authentication request, a similarity (score) when it is determined that the authentication is successful, and the like.

In FIG. 11, for easy understanding, a reference numeral assigned to each terminal illustrated in FIG. 2 is used as the terminal ID. The authentication result database illustrated in FIG. 11 is an example, and is not intended to limit items and the like to be stored. For example, the authentication result database may store a date and time when the authentication succeeds (authentication time) and the like.

In a case where a result of successful authentication is obtained, the authentication unit 404 updates the authentication result database. Specifically, when the token ID of the person to be authenticated is not registered in the authentication result database, the authentication unit 404 adds a new entry to the database and writes details of the authentication process. When the token ID of the person to be authenticated is registered in the authentication result database, the authentication unit 404 writes the result of the authentication process in the authentication result detailed information field of the related entry.

Since the order of boarding procedures at the airport is determined in advance, the order also exists in the terminal IDs stored in the authentication result database. For example, in the example of FIG. 2, in a normal procedure, the procedure is performed in order of the baggage checking machine 11, the passenger passage system 12, the gate device 13, and the boarding gate device 14. Therefore, details of the authentication process are stored in the authentication result database in the order of the above terminals. Since the procedure in the baggage checking machine 11 is not essential, the authentication result by the terminal may not be stored in the authentication result database.

The verification information generation unit 405 is a means configured to generate the authentication result verification information described above. The verification information generation unit 405 generates authentication result verification information including at least the registered face image, the terminal ID, and the acquired face image acquired by the terminal. The authentication result verification information generated by the verification information generation unit 405 is provided to the staff or the like of an airport or an airline company.

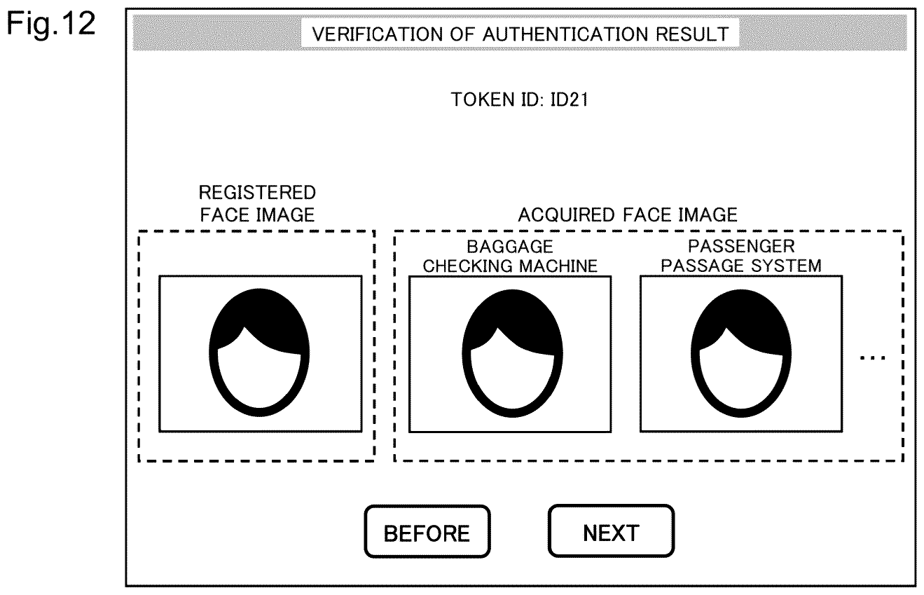

For example, the verification information generation unit 405 transmits the generated authentication result verification information to the staff terminal 30. Based on the received authentication result verification information, the staff terminal 30 generates a display (GUI) as illustrated in FIG. 12. The staff terminal 30 performs display in such a way that the registered face image of the entry (authentication-successful person) stored in the authentication result database and at least one or more acquired face images can be simultaneously checked. The staff terminal 30 also displays the name and the like of the terminal that acquired the acquired face image based on the terminal ID.

The verification information generation unit 405 generates authentication result verification information in response to a request from the staff (the staff terminal 30) to transmit the generated authentication result verification information to the staff terminal 30. The staff checks the display as illustrated in FIG. 12, and presses the “next button” when it is determined that no false authentication of acceptance of another person occurs. In response to detection of pressing of the “next button”, the staff terminal 30 requests the server device 20 to transmit new authentication result verification information.

Upon receiving a new request, the verification information generation unit 405 generates authentication result verification information from the next entry in the authentication result database to transmit the generated authentication result verification information to the staff terminal 30.

In a case where the registered face image and the acquired face image are compared, and the acquired face image is considered to be a face image captured from a different person, the staff or the like determines that the acceptance of another person occurs. In this case, the staff or the like inputs the token ID to the server device 20 to acquire detailed information (for example, name, airline, flight number, and the like) about the person who is falsely authenticated. Based on the acquired detailed information, the staff or the like will respond appropriately to the person who is falsely authenticated. Specifically, the staff or the like checks the passport or the like possessed by the person who is falsely authenticated, and corrects inconsistency or the like caused by the false authentication.

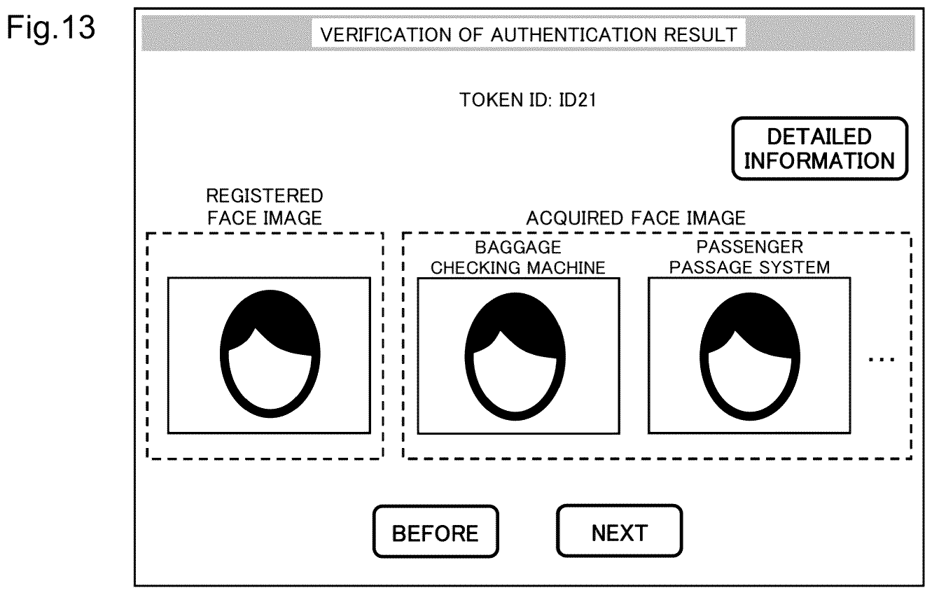

Alternatively, the staff terminal 30 may display a button or the like for obtaining detailed information about the person who is falsely authenticated (see FIG. 13). In a case where the staff or the like requests presentation of detailed information (in a case where the detailed information button is pressed), the staff terminal 30 notifies the server device 20 of the request. In response to the notification, the verification information generation unit 405 of the server device searches the operation information database using the token ID as a key. The verification information generation unit 405 transmits the name, the airline code, the flight number, and the like of the entry identified by the search result to the staff terminal 30. The staff terminal 30 displays the obtained information. Alternatively, the verification information generation unit 405 may generate a passage history of passing through the terminals related to a person who is falsely authenticated (a passenger selected by the staff or the like) with reference to the authentication result database to transmit the passage history to the staff terminal 30. The staff terminal 30 may display the passage history.

In a case where a plurality of pieces of authentication result detailed information is stored for the same authentication-successful person, the verification information generation unit 405 generates the authentication result verification information including the terminal ID and the acquired face image related to each of the plurality of pieces of authentication result detailed information. The staff terminal 30 can generate a display (GUI) as illustrated in FIGS. 12 and 13 using such authentication result verification information.

The storage unit 406 stores various types of information necessary for the operation of the server device 20. In the storage unit 406, a token ID information database, an operation information database, and an authentication result database are constructed.

[Staff Terminal]

The staff terminal 30 may include a display device such as a liquid crystal panel and an operation device such as a touch panel, and may have an information output function and an information input function. The staff terminal 30 can be achieved by a commercially available computer or the like, and the internal processing configuration and the like are obvious to those skilled in the art, and thus the description thereof will be omitted.

[System Operation]

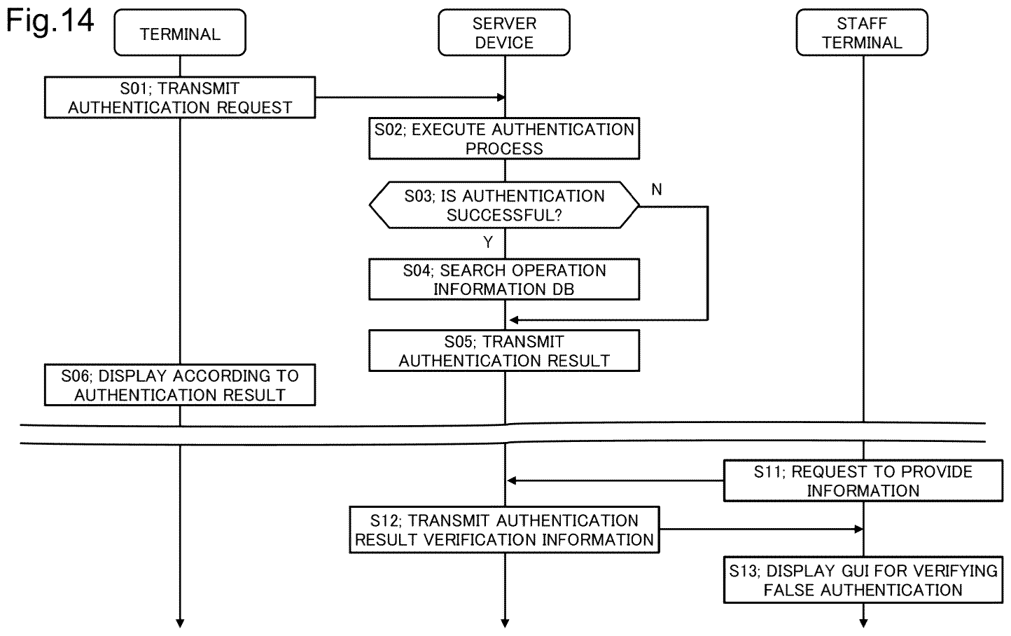

Next, an operation of the boarding procedure system according to the first example embodiment will be described. FIG. 14 is a sequence diagram illustrating an example of the operation of the boarding procedure system according to the first example embodiment. An operation when the authentication process of the user is executed and a subsequent operation will be described with reference to FIG. 14. Description of the operation related to system registration will be omitted.

The terminal (any of the baggage checking machine 11, the passenger passage system 12, the gate device 13, and the boarding gate device 14) acquires a face image of the user (person to be authenticated) to transmit an authentication request to the server device 20 (step S01).

The server device 20 generates a feature amount from the face image included in the authentication request, and executes the authentication process using the token ID information database (step S02).

When the authentication succeeds (step S03: Yes branch), the server device 20 searches the operation information database using the token ID obtained by the collation processing as a key (step S04).

When the authentication fails (step S03, No branch), the server device 20 executes the processing in and after step S05.

Server device 20 transmits the authentication result (authentication success, authentication failure) to the terminal (touch point) (step S05).

The terminal performs display according to the authentication result acquired from the server device 20 (step S06). The terminal executes the boarding procedure of the user according to the authentication result. Description of the operation will be omitted. Each terminal may execute the allocated function.

The staff terminal 30 requests the server device 20 to provide information for verifying the occurrence of false authentication (acceptance of another person) (step S11).

The server device 20 generates authentication result verification information with reference to the authentication result database. The server device 20 transmits the generated authentication result verification information to the staff terminal 30 (step S12).

The staff terminal 30 displays a GUI for verifying the occurrence of the false authentication based on the authentication result verification information (step S13).

As described above, when the authentication of the person to be authenticated succeeds, the boarding procedure system according to the first example embodiment stores details of the authentication process (authentication result) in the authentication result database. The server device 20 refers to the database in response to a request from the staff or the like, and generates authentication result verification information for the staff or the like verifying the occurrence of false authentication (acceptance of another person). The authentication result verification information includes the terminal ID of the terminal that has triggered the occurrence of the authentication process, in addition to the registered face image and the acquired face image. Therefore, the staff terminal 30 can identify in which of a plurality of terminals (terminals such as the baggage checking machine 11) the acceptance of another person occurs. In addition, since the staff terminal 30 can present the staff with detailed information about the person involved in acceptance of another person (for example, a boarding flight number, an airline company, or the like), the staff can quickly take appropriate measures.

### Second Example Embodiment

Next, the second example embodiment will be described in detail with reference to the drawings.

In the first example embodiment, each entry stored in the authentication result database is set as a target whose information is to be provided (target for which authentication result verification information is generated). However, with such a measure, in a case where a large number of entries are included in the authentication result database, it takes a lot of labor to verify the acceptance of another person by the staff or the like.

In the second example embodiment, in order to reduce labor of staff members, a case of narrowing down entries as targets for which authentication result verification information is generated will be described.

Since a schematic configuration of a boarding procedure system according to the second example embodiment can be the same as that of the first example embodiment, a description corresponding to FIG. 2 is omitted. Similarly, since the processing configurations of the server device 20 and the terminal according to the second example embodiment can be the same as those of the first example embodiment, the description thereof will be omitted.

Hereinafter, differences between the first and second example embodiments will be described.

The verification information generation unit 405 according to the second example embodiment generates the authentication result verification information about the authentication result in which there is a high possibility that the acceptance of another person occurs among the results of the biometric authentication. The verification information generation unit 405 excludes the authentication result (entry in the authentication result database) in which the possibility that the acceptance of another person occurs is low from the target for which the authentication result verification information is generated.

The verification information generation unit 405 determines whether to generate the authentication result verification information for each entry (authentication-successful person) of the authentication result database at the time of providing information or in advance in preparation for providing information. More specifically, the verification information generation unit 405 analyzes the authentication result detailed information, and determines whether each entry of the authentication result database is set as a target for which the authentication result verification information is generated.

For example, in a case where at least one or more pieces of authentication result detailed information included in each entry includes information having a high possibility of false authentication (acceptance of another person), the verification information generation unit 405 sets an entry including the information as a target whose information is to be provided. In other words, the verification information generation unit 405 does not set the entry including only the authentication result detailed information in which the possibility that the false authentication is generated is low as the target for which the authentication result verification information is generated.

For example, the verification information generation unit 405 determines whether each entry is set as a target for which the authentication result verification information is generated based on the similarity used when the authentication request from the terminal is processed. In a case where the similarity included in the authentication result detailed information is smaller than a predetermined threshold value, the verification information generation unit 405 sets the entry including the authentication result detailed information as the target for which the authentication result verification information is generated.

In the example of FIG. 11, in a case where the similarity S11 of the authentication result detailed information 1 is smaller than a threshold value TH1 for the authentication-successful person whose token ID is “ID11”, the authentication result verification information related to the authentication-successful person is generated. In this case, although the authentication is successful, the accuracy is low, and the probability of the false authentication is high for the authentication result related to the authentication-successful person.

Alternatively, the verification information generation unit 405 may determine whether to generate the authentication result verification information based on the time series data having the similarity described in each entry of the authentication result database (the similarity included in each of the plurality of pieces of authentication result detailed information) as an element. More specifically, the verification information generation unit 405 may make the above determination based on a result of the statistical process on the time series data.

For example, in a case where the change rate is larger than a predetermined threshold value in the preceding and subsequent similarities, the verification information generation unit 405 sets the related entry as the target for which the authentication result verification information is generated.

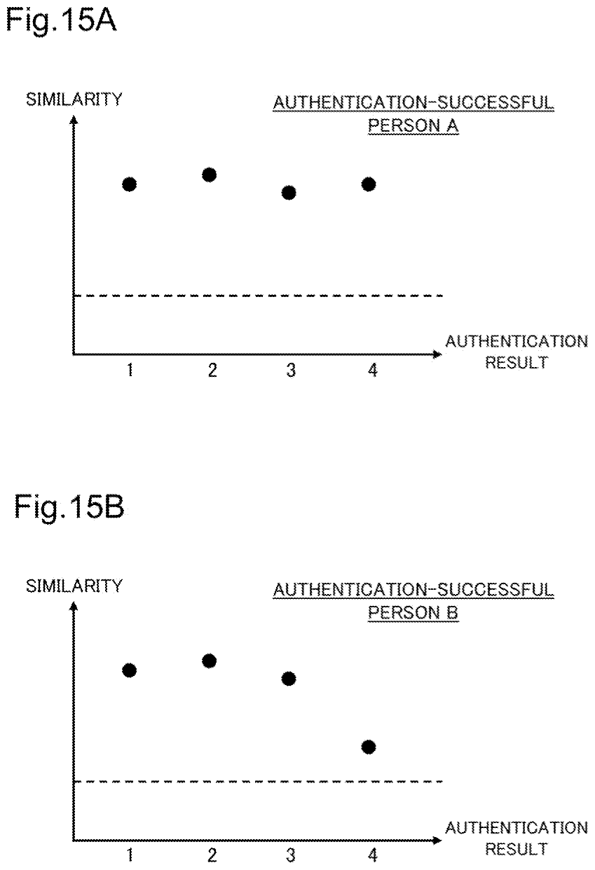

For example, as for the authentication-successful person A, the similarity obtained by the result of the authentication process is graphed as illustrated in FIG. 15(a). As for the authentication-successful person B, the similarity is graphed as illustrated in FIG. 15(b). A dotted line illustrated in FIG. 15 indicates a value of the threshold value TH2 at which the authentication is determined to be successful. That is, each similarity plotted in FIG. 15 is larger than the threshold value TH2 at which the authentication is determined to be successful.

Comparing the two graphs in FIG. 15, in FIG. 15(a), the similarity (score) is stable at a high value (the change rate between the similarities is small). This fact indicates that similarities calculated in the four authentication processes are similar, and indicates that there is a high possibility that a face image of the same person is acquired in each terminal.

On the other hand, in FIG. 15(b), the change rate of the similarity is large between the third to fourth authentication results. This fact indicates that the similarity between the registered face image and the acquired face image used in the fourth authentication process is larger than the threshold value TH2 for determining the authentication success, but the acquired face image used in the third authentication process and the acquired face image used in the fourth authentication process are face images of different persons. Therefore, the verification information generation unit 405 determines that there is a high probability that the acceptance of another person occurs in the authentication related to the authentication-successful person B, and sets the authentication-successful person B as a target for which authentication result detailed information is generated.

Alternatively, the verification information generation unit 405 may determine whether to generate the authentication result detailed information based on “variation” regarding the time series data of the feature amount described in each entry. Specifically, the verification information generation unit 405 calculates an index (variance, standard deviation) indicating the variation in the time series data. In a case where an index (variance, standard deviation) indicating the variation calculated is larger than a predetermined threshold value, the verification information generation unit 405 sets the related entry as a target for which the authentication result detailed information is generated.

Alternatively, the verification information generation unit 405 may determine whether to generate the authentication result detailed information using a similarity (first similarity) having the largest value among the plurality of similarities calculated at the time of the authentication process and a similarity (second similarity; the first similarity >the second similarity) having the second largest value. In this case, the authentication unit 404 stores the two similarities in the authentication result database.

In a case where the difference between the first similarity and the second similarity is smaller than a threshold value TH3 for the authentication result detailed information about each entry of the authentication result database, the verification information generation unit 405 sets the entry as a target for which the authentication result verification information is generated.

Here, the fact that the difference between the first similarity and the second similarity is large indicates that the face of the person determined to be the second closest to the person to be authenticated does not resemble the face of the person to be authenticated (the subject person). On the other hand, the fact that the difference between the first similarity and the second similarity is small indicates that the face of the person who is determined to be the second closest to the person to be authenticated resembles the face of the person to be authenticated. For example, in a case where the person to be authenticated is a twin and face images of the twins are registered, the difference between the similarity (first similarity) based on the face image of the subject person and the similarity (second similarity) based on the another face image of the twins is reduced.

Using the above fact, the verification information generation unit 405 determines that the authentication in which the difference between the two similarities is smaller than the predetermined threshold value is a result in which the probability of the occurrence of the acceptance of another person is high.

Alternatively, the verification information generation unit 405 may determine whether to generate the authentication result detailed information based on an index or the like different from the similarity between the face images based on the feature amount generated from the face image. In the biometric authentication, the occurrence of the false authentication (acceptance of another person) is caused by the similarity between the “face” on the collation side and the “face” on the registration side. More precisely, when the positions of the eyes and nose and the distance between these feature points are almost the same, false authentication (acceptance of another person) may occur even for the faces of different persons. Here, in the boarding procedure system at the airport, the registered face image is input to the server device 20 at the time of check-in, and then the terminal (the boarding gate device 14 or the like) requests the server device 20 for biometric authentication in a relatively short time. It is difficult to assume that the hairstyle, the presence or absence of wearing glasses, the clothes, and the like of the person to be authenticated change in such a short period. The verification information generation unit 405 may determine whether to generate the authentication result detailed information using such features and characteristics of the biometric authentication at the airport.

More specifically, the verification information generation unit 405 calculates the similarity between the two images by a method different from the method using the feature amount. For example, the verification information generation unit 405 sets a low value for the similarity when hairstyles of persons appearing in the two face images are different. Alternatively, the verification information generation unit 405 sets a low value for the similarity when the eyeglasses are shown in one face image and the eyeglasses are not shown in the other face image. Alternatively, when the clothes of the persons appearing in the two face images are different, the verification information generation unit 405 sets a low value for the similarity. In a case where the similarity calculated by the method as described above is lower than a threshold value TH4, the verification information generation unit 405 determines that the probability of the occurrence of the acceptance of another person is high. That is, the verification information generation unit 405 may determine whether to generate the authentication result detailed information based on the similarity between the images calculated by a method different from the method using the similarity based on the feature amount.

When determining the similarity between the hairstyles, the verification information generation unit 405 may compare the area of the region in the upper part of the face, or may use the shape of the region. The verification information generation unit 405 may determine whether the user wears the glasses using a method such as template matching. When determining the clothing identity, the verification information generation unit 405 may use a frequency analysis result of a region other than the face region. The server device may determine the identity of the clothing according to whether the pattern or texture of the region other than the face region are different.

The verification information generation unit 405 sets, as a target for which the authentication result verification information is generated, an authentication result (entry) in which it is highly probable that false authentication has occurred by the above-described method or another method. That is, the display as illustrated in FIGS. 12 and 13 is not performed for the authentication result in which it is determined that the possibility that the false authentication (acceptance of another person) has occurred is low. In other words, the staff or the like may verify the authentication result (registered face image, acquired face image) with high probability that the false authentication has occurred.

As described above, when providing information to the staff or the like, the server device 20 according to the second example embodiment generates the authentication result verification information from the authentication result (authentication result detailed information) with high probability that the acceptance of another person has occurred. As described above, since the server device 20 narrows down the information about the authentication result with high probability that the false authentication has occurred and provides the staff or the like with the information, it is possible to reduce the burden on the staff who checks the provided information.

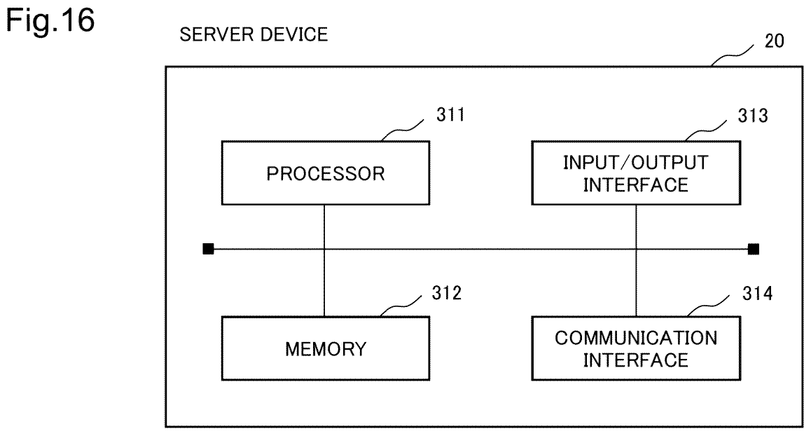

Next, hardware of each device constituting the boarding procedure system will be described. FIG. 16 is a diagram illustrating an example of a hardware configuration of the server device 20.

The server device 20 can be configured by an information processing device (so-called computer), and has the configuration illustrated in FIG. 16. For example, the server device 20 includes a processor 311, a memory 312, an input/output interface 313, a communication interface 314, and the like. The components such as the processor 311 are connected by an internal bus or the like and are configured to be able to communicate with each other.

However, the configuration illustrated in FIG. 16 is not intended to limit the hardware configuration of the server device 20. The server device 20 may include hardware not illustrated or may not include the input/output interface 313 as necessary. The number of processors 311 and the like included in the server device 20 is not limited to the example of FIG. 16, and for example, a plurality of processors 311 may be included in the server device 20.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 executes various programs including an operating system (OS).

The memory 312 is a random access memory (RAM), a read only memory (ROM), a hard disk drive (HDD), a solid state drive (SSD), or the like. The memory 312 stores an OS program, an application program, and various pieces of data.

The input/output interface 313 is an interface of a display device or an input device (not illustrated). The display device is, for example, a liquid crystal display or the like. The input device is, for example, a device that receives a user operation such as a keyboard or a mouse.

The communication interface 314 is a circuit, a module, or the like that communicates with another device. For example, the communication interface 314 includes a network interface card (NIC) or the like.

The functions of the server device 20 are implemented by various processing modules. The processing module is implemented, for example, by the processor 311 executing a program stored in the memory 312. The program can be recorded in a computer-readable storage medium. The storage medium may be a non-transient medium such as a semiconductor memory, a hard disk, a magnetic recording medium, or an optical recording medium. That is, the present invention can also be embodied as a computer program product. The program can be downloaded via a network or updated using a storage medium storing the program. Furthermore, the processing module may be achieved by a semiconductor chip.

The check-in terminal 10, the boarding gate device 14, the staff terminal 30, and the like can also be configured by the information processing device as in the server device 20, and since there is no difference in the basic hardware configuration from the server device 20, the description thereof will be omitted. The check-in terminal 10 or the like may include a camera or the like.

The server device 20 includes a computer, and the function of the server device 20 can be achieved by causing the computer to execute a program. The server device 20 executes the method for controlling the server device by the program.

### Modification

The configuration, operation, and the like of the boarding procedure system described in the above example embodiment are merely examples, and are not intended to limit the configuration and the like of the system.

In the above example embodiment, the description is made in which the system registration is performed after the check-in procedure of the user, but the system registration may be performed before the check-in procedure. In this case, since the boarding pass is not issued before the check-in procedure, the server device 20 may perform system registration using the information about the airline ticket instead of the boarding pass.

In the above example embodiment, a case where system registration (registration for achieving the boarding procedure using biometric authentication) is performed by the check-in terminal 10 is described. However, the system registration may be performed by a device or a terminal other than the check-in terminal 10. For example, a device dedicated to system registration may be installed at an airport, or system registration may be performed at a terminal (touch point) such as the baggage checking machine 11 or the passenger passage system 12.

In the above example embodiment, a case where a series of boarding procedures is performed by biometric authentication is described, but some procedures may be performed by biometric authentication. For example, in FIG. 2, system registration may be performed by the baggage checking machine 11, and procedures (security inspection and the like) after baggage checking may be performed by biometric authentication. In other words, part of the series of boarding procedures may be performed in a manned booth or the like.

In the above example embodiment, the case where the server device 20 includes three databases is described. However, the token ID information database, the operation information database, and the authentication result database constructed in the server device 20 may be constructed in a database server different from the server device 20. That is, the boarding procedure system may include various means (for example, token generation means) described in the above example embodiment.

In the above example embodiment, the case where the authentication request includes the face image is described, but the authentication request may include a feature amount generated from the face image. In this case, the server device 20 may process the authentication request using the feature amount extracted from the authentication request and the feature amount registered in the token ID information database.

In the second example embodiment, the server device 20 selects the authentication result based on the similarity or the like, and narrows down the verification target regarding the occurrence of the acceptance of another person. The selection method described above is an example, and the server device 20 (verification information generation unit 405) may perform narrowing based on other conditions or the like. For example, server device 20 may narrow down the target for which the authentication result verification information is generated based on the seat grade (highest-grade passenger seat, upper-grade cabin, and ordinary passenger seat) of the authentication-successful person. For example, the server device 20 may verify the occurrence of the acceptance of another person only for the passenger whose seat grade is the first class. In this case, the staff member can carefully monitor the occurrence of false authentication concerning first class passengers (passengers with whom the airline company or the like wants to avoid trouble).

Alternatively, the server device 20 may determine whether to generate the authentication result verification information based on the order of the terminal IDs stored in the authentication result database. As described above, the order of the procedures at the airport is predetermined. Therefore, the server device 20 may determine that the probability that the false authentication has occurred is high for the entry on which the biometric authentication has been performed in an order different from the predetermined order, and may set the entry as the target for which the authentication result verification information is generated. For example, the verification information generation unit 405 may determine an entry for which authentication has occurred (recorded) in the baggage checking machine 11 after authentication in the gate device 13 as a target for which the authentication result verification information is generated. This is because it is normally impossible to assume that authentication is performed in the baggage checking machine 11 after the gate device 13.

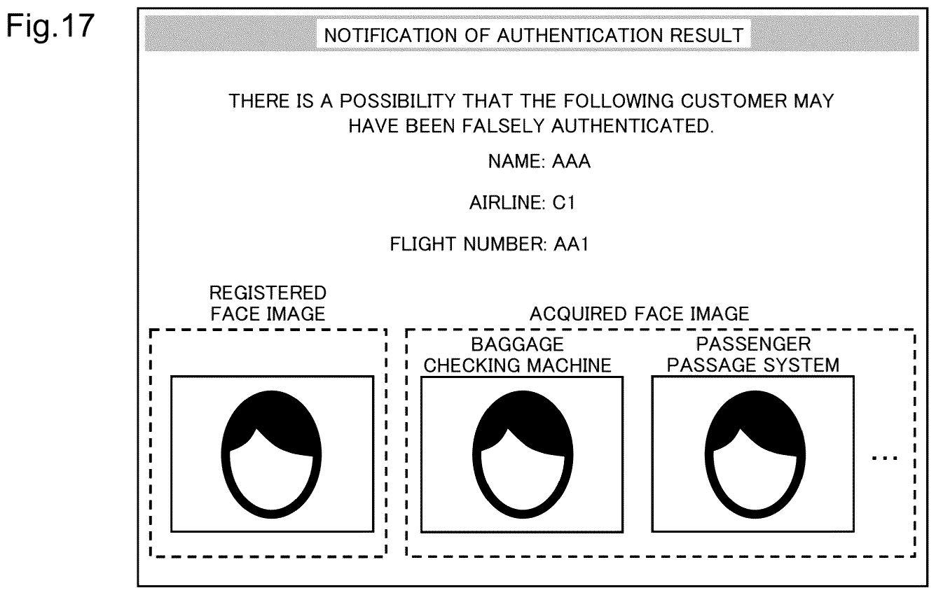

As described in the second example embodiment, the server device 20 may voluntarily provide the information periodically or at a predetermined timing in addition to providing the information by the authentication result verification information based on an instruction from the staff or the like. For example, the server device 20 (verification information generation unit 405) analyzes the authentication result (authentication result detailed information) stored in the authentication result database periodically or at a predetermined timing, and determines whether transmission of the authentication result verification information is necessary. Specifically, the server device 20 determines the necessity of transmission by the method described in the second example embodiment or another method. In a case where the server device 20 determines that it is necessary to transmit the authentication result verification information, the server device 20 notifies (notification, warning) the staff terminal 30 of the determination. At this time, the server device 20 may notify the staff terminal 30 of information about the name of the person involved in the occurrence of the acceptance of another person and the flight. Specifically, the server device 20 may transmit data capable of generating a display as illustrated in FIG. 17 to the staff terminal 30.

The staff who viewed the display as illustrated in FIG. 17 goes to the displayed passenger and checks whether false authentication (acceptance of another person) has practically occurred. When the acceptance of another person occurs, the staff corrects the contradiction caused by the authentication of another person. For example, the staff corrects data stored in the server device 20. As illustrated in FIG. 17, the staff can compare the face images acquired by each of the terminals, so that the staff can identify at which terminal the false authentication has generated. For example, when the acquired face image acquired by the boarding gate device 14 is different from another acquired face image, the staff or the like can determine that the acceptance of another person occurs in the boarding gate device 14.

As described above, the verification information generation unit 405 of the server device 20 may analyze the authentication result detailed information periodically or at a predetermined timing, and determine whether to transmit the authentication result verification information. The verification information generation unit 405 may transmit, to the staff terminal, information about the flight of the related authentication-successful person together with the authentication result verification information determined to be required to be generated.

The server device 20 may identify a terminal that has acquired the face image used for the authentication from the authentication result in which it is determined that the probability of the occurrence of the acceptance of another person is high, and notify the staff or the like of information about the identified terminal. For example, in the example of FIG. 15(b), it is determined that the probability of the occurrence of the acceptance of another person is high in the fourth authentication process (for example, processing related to an authentication request from the boarding gate device 14). Therefore, the server device 20 notifies the staff that there is a high possibility that the acceptance of another person occurs at the time of authentication in the boarding gate device 14.

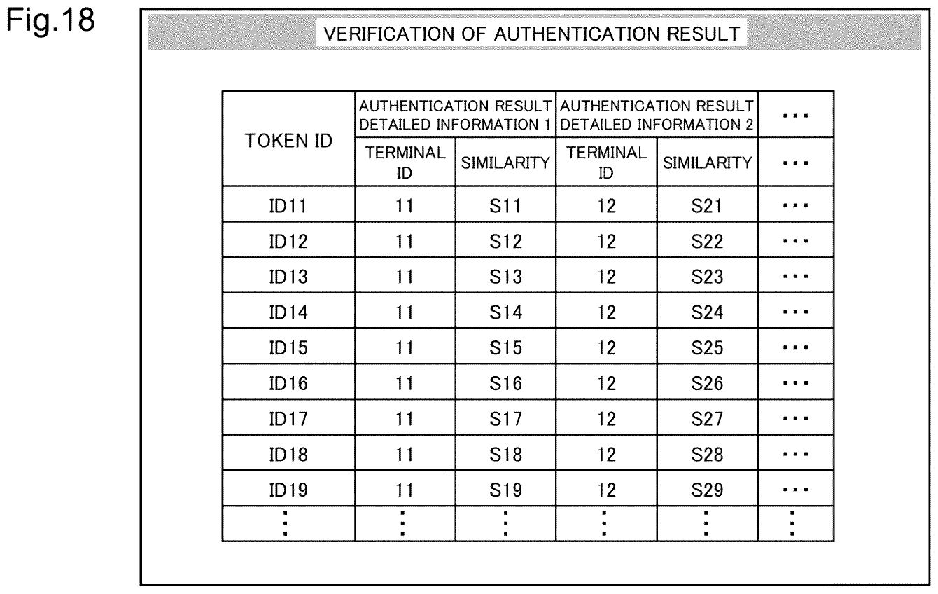

In the above example embodiment, the description is made in which the server device 20 transmits the authentication result verification information about one passenger (authentication-successful person) to the staff terminal 30. However, the server device 20 may collectively transmit the authentication result verification information about the plurality of passengers to the staff terminal 30. For example, the server device 20 may generate authentication result verification information related to each of a plurality of entries among entries described in the authentication database illustrated in FIG. 11 to transmit the authentication result verification information to the staff terminal 30. The staff terminal 30 may display a list as illustrated in FIG. 18 from the acquired information.

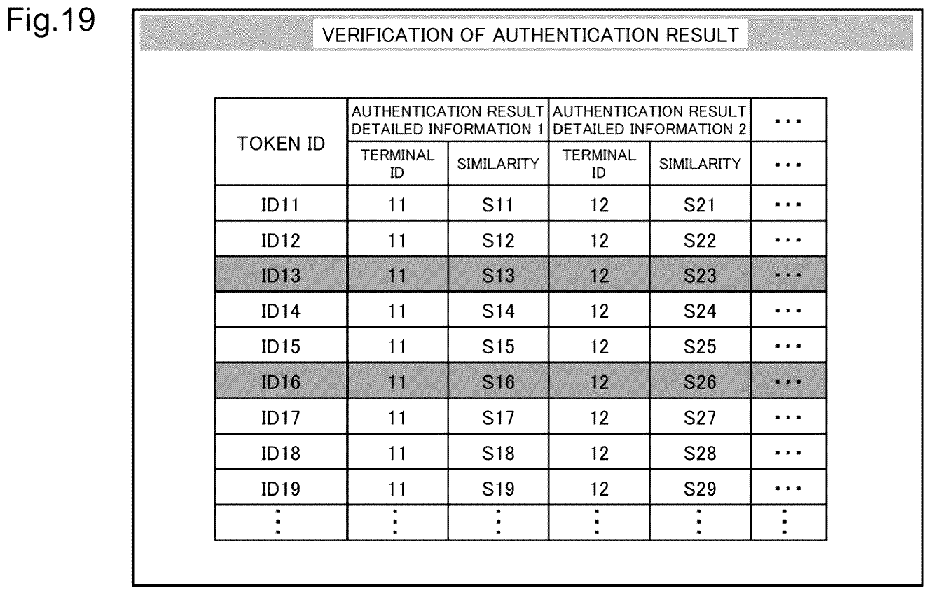

Alternatively, the server device 20 may transmit, to the staff terminal 30, authentication result verification information to which a flag indicating whether the probability that the acceptance of another person occurs is high is assigned according to the similarity or the like used at the time of authentication. As illustrated in FIG. 19, the staff terminal 30 may perform display to emphasize a result having a high possibility that the acceptance of another person occurs by referring to the flag. In FIG. 19, the entry colored in gray indicates an entry with high probability that the acceptance of another person occurs.

Alternatively, when the staff member who viewed the display illustrated in FIGS. 18 and 19 selects an entry, the staff terminal 30 may perform display (display including a face image) as illustrated in FIGS. 12 and 13. Alternatively, the staff terminal 30 may display the name, the airline code, the flight number, and the like of the authentication-successful person together with the face image.

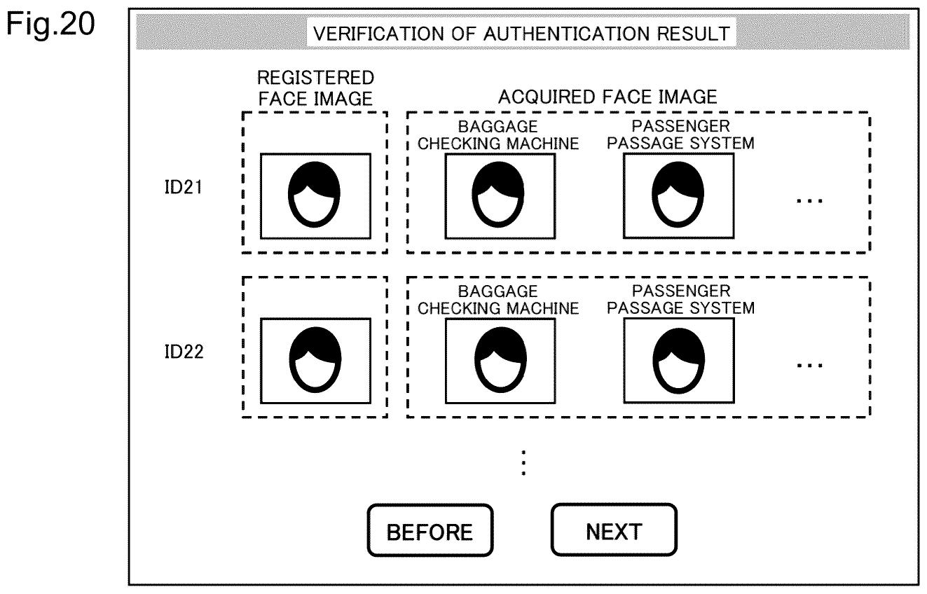

In the above example embodiment, with reference to FIGS. 12 and 13, the case of displaying the authentication result verification target related to one entry on one screen is described. However, the authentication result verification target (the authentication result of the authentication-successful person) related to a plurality of entries may be displayed on one screen (see FIG. 20).

In the above example embodiment, the case of identifying the authentication result having a high probability of occurrence of the acceptance of another person based on the similarity or the like is described. However, the identification may be performed using a learning model generated by machine learning. Specifically, the system administrator or the like collects data (acquired face image, registered face image) at the time of a large number of occurrences of acceptance of another person. The system administrator or the like assigns a label regarding authentication failure to the collected data to generate teacher data. The system administrator or the like inputs the teacher data to the learning device and generates a learning model (classification model). The learning model is implemented in the server device 20. The server device 20 inputs the two face images to the learning model and obtains a determination result (occurrence or non-occurrence of the acceptance of another person). In a case where the determination result is the “occurrence of acceptance of another person”, the server device 20 may set the related entry as a target for which information is provided or a target for which an alert is issued to the staff member. Any algorithm such as a support vector machine, boosting, or a neural network can be used to generate the learning model. A known technique can be used for the algorithm such as the support vector machine, and thus the description thereof will be omitted.

In the above example embodiment, the face image and the feature amount generated from the face image are treated as “biometric information”, and the operation of the system and the like have been described. However, another information instead of the face image or the like may be used as the “biometric information”. For example, in a case where the voice print authentication is used, the occurrence of the acceptance of another person may be detected by reproducing voice print information (voice data) registered in advance.

In the above example embodiment, the case of determining whether to generate the authentication result verification information based on the similarity and the time series data having the similarity as an element is described. The server device 20 may determine whether it is necessary to the authentication result verification information by combining the plurality of methods described above. For example, the server device 20 determines whether to generate the authentication result verification information for each of the plurality of determination methods. When at least one of the plurality of obtained determination results indicates that “generation is necessary”, the server device 20 may generate the authentication result verification information from the related entry. Alternatively, the server device 20 may determine whether to generate the authentication result verification information based on a result of the statistical process on a plurality of determination results. For example, in a case where the number of the results determined to be that “generation is necessary” is larger than a predetermined threshold value, the server device 20 may generate the authentication result verification information from the related entry.

In the above example embodiment, the case where the server device 20 provides the authentication result verification information to the staff or the like via the staff terminal 30 is described. However, the server device 20 may provide the information using a display device or the like of the server device 20. Alternatively, the server device 20 may provide the information via a dashboard or the like installed in a management room or the like in which the staff or the like is located.

A form of data transmission and reception between the check-in terminal 10 and the like and the server device 20 is not particularly limited, but data transmitted and received between these devices may be encrypted. The boarding pass information and the passport information include personal information, and in order to appropriately protect the personal information, it is desirable that encrypted data be transmitted and received.

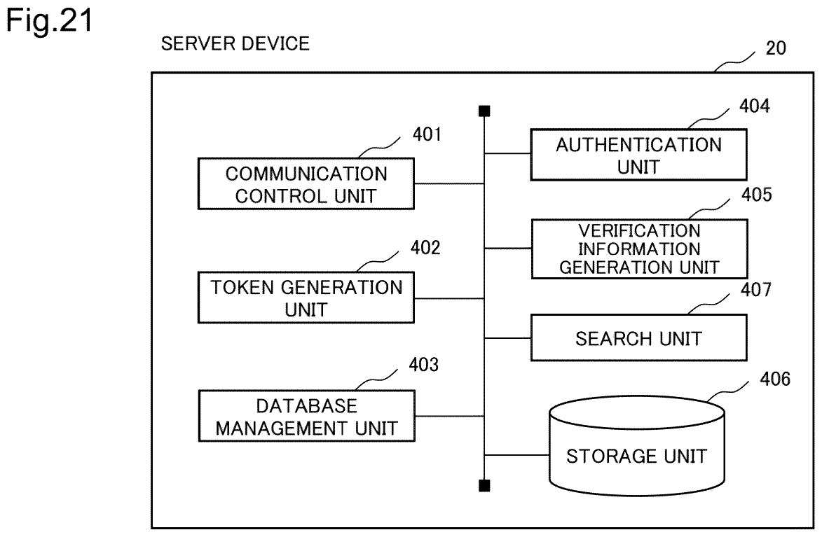

The server device 20 may provide a search function of the authentication result database to the staff or the like. For example, the server device 20 may include a “search unit 407” that searches for an authentication result in which there is a high possibility that the acceptance of another person occurs (see FIG. 21). The search unit 407 acquires the search condition from the staff terminal 30 and the like. The search unit 407 searches for an authentication result matching the condition and returns the search result. For example, the search unit 407 searches for an entry (authentication result) in which a difference between the similarities of the authentication-successful person (a difference between the first similarity and the second similarity) is equal to or less than a predetermined threshold value based on information input from the staff or the like.

In the flow chart (flowchart and sequence diagram) used in the above description, a plurality of steps (processes) is described in order, but the execution order of the steps executed in the example embodiment is not limited to the described order. In the example embodiment, for example, the order of the illustrated steps can be changed within a range in which there is no problem in terms of content, such as executing each step in parallel.

The above example embodiments have been described in detail in order to facilitate understanding of the present disclosure, and it is not intended that all the configurations described above are necessary. In a case where a plurality of example embodiments is described, each example embodiment may be used alone or in combination. For example, part of the configuration of the example embodiment can be replaced with the configuration of another example embodiment, or the configuration of another example embodiment can be added to the configuration of the example embodiment. Furthermore, it is possible to add, delete, and replace other configurations for part of the configuration of the example embodiment.

Although the industrial applicability of the present invention is apparent from the above description, the present invention is suitably applicable to a boarding procedure system at an airport or the like. However, the application of the present disclosure is not limited to the airport procedure, and the present disclosure can be applied to a system requiring a plurality of procedures. For example, the present disclosure can also be applied to entrance/exit control of an event venue or the like. For example, the server device 20 may analyze the authentication history in the event venue and notify the event promoter or the like of a result in which the false authentication is strongly suspected.

Some or all of the above example embodiments may be described as the following Supplementary Notes, but are not limited to the following.

### [Supplementary Note 1]

A server device including
a reception unit that receives, from a terminal that has acquired biometric information about a person to be authenticated among a plurality of terminals, an authentication request including biometric information about the person to be authenticated,
an authentication unit that performs biometric authentication using biometric information about the person to be authenticated and biometric information about each of a plurality of users registered in advance, and
a storage unit that stores, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

### [Supplementary Note 2]

The server device according to Supplementary Note 1, wherein
the authentication result detailed information stored in the storage unit further includes a terminal ID for identifying a transmission source of the authentication request, and
the server device further includes a generation unit that generates authentication result verification information including at least the biometric information registered in advance, the terminal ID, and biometric information acquired by the terminal.

### [Supplementary Note 3]

The server device according to Supplementary Note 2, wherein the authentication result detailed information includes a similarity when it is determined that authentication succeeds by the biometric authentication.

### [Supplementary Note 4]

The server device according to Supplementary Note 3, wherein the generation unit analyzes the authentication result detailed information and determines whether to generate the authentication result verification information.

### [Supplementary Note 5]

The server device according to Supplementary Note 4, wherein the generation unit determines whether to generate the authentication result verification information based on the similarity.

### [Supplementary Note 6]

The server device according to Supplementary Note 5, wherein the generation unit generates the authentication result verification information in a case where a similarity included in the authentication result detailed information is smaller than a first threshold value.

### [Supplementary Note 7]

The server device according to Supplementary Note 5 or 6, wherein the generation unit generates the authentication result verification information in a case where a difference between a first similarity having a largest value and a second similarity having a second largest value is smaller than a second threshold value.

### [Supplementary Note 8]

The server device according to any one of Supplementary Notes 5 to 7, wherein
in a case where a plurality of pieces of the authentication result detailed information is stored for a same authentication-successful person,
the generation unit
determines whether to generate the authentication result detailed information based on a result of a statistical process on time series data having a similarity included in each of the plurality of pieces of authentication result detailed information as an element.

### [Supplementary Note 9]

The server device according to any one of Supplementary Notes 2 to 8, wherein the generation unit transmits the authentication result verification information to a staff terminal used by a staff member of an airport or an airline.

### [Supplementary Note 10]

The server device according to Supplementary Note 9, wherein the generation unit analyzes the authentication result detailed information periodically or at a predetermined timing and transmits, to the staff terminal, information about a flight of a related authentication-successful person together with the authentication result verification information determined to be required to be generated.

### [Supplementary Note 11]

The server device according to any one of Supplementary Notes 1 to 10, wherein the biometric information is a face image or a feature amount extracted from the face image.

### [Supplementary Note 12]

A system including
a plurality of terminals, and
a server device connected to the plurality of terminals, wherein
the server device includes
a reception unit that receives, from a terminal that has acquired biometric information about a person to be authenticated among a plurality of terminals, an authentication request including biometric information about the person to be authenticated,
an authentication unit that performs biometric authentication using biometric information about the person to be authenticated and biometric information about each of a plurality of users registered in advance, and
a storage unit that stores, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

### [Supplementary Note 13]

A method for controlling a server device, the method including:
by the server device,
receiving, from a terminal that has acquired biometric information about a person to be authenticated among a plurality of terminals, an authentication request including biometric information about the person to be authenticated;
performing biometric authentication using biometric information about the person to be authenticated and biometric information about each of a plurality of users registered in advance; and
storing, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

### [Supplementary Note 14]

A computer-readable storage medium storing a program for causing a computer mounted on a server device to execute processing including:
receiving, from a terminal that has acquired biometric information about a person to be authenticated among a plurality of terminals, an authentication request including biometric information about the person to be authenticated;
performing biometric authentication using biometric information about the person to be authenticated and biometric information about each of a plurality of users registered in advance; and
storing, for an authentication-successful person who has succeeded in the biometric authentication, the biometric information registered in advance and authentication result detailed information including details when the authentication request is processed, the authentication result detailed information including biometric information acquired by a terminal that is a transmission source of the authentication request in association with each other.

The disclosures of the cited prior art documents are incorporated herein by reference. While the exemplary example embodiments of the present invention have been described, the present invention is not limited to these example embodiments. It will be understood by those of ordinary skill in the art that these example embodiments are exemplary only and that various variations may be made therein without departing from the scope and spirit of the present invention as defined by the claims. That is, it goes without saying that the present invention includes various modifications and corrections that can be made by those of ordinary skill in the art in accordance with the entire disclosure including the claims and the technical idea.

### REFERENCE SIGNS LIST

10 check-in terminal
11 baggage checking machine
12 passenger passage system
13 gate device
14 boarding gate device
20, 100 server device
30 staff terminal
101 reception unit
102, 404 authentication unit
103, 206, 306, 406 storage unit
201, 301, 401 communication control unit
202 system registration unit
203 token issuance request unit
204, 304 message output unit
205 check-in execution unit
211 boarding pass information acquisition unit
212 passport information acquisition unit
213, 302 biometric information acquisition unit
303 authentication request unit
305 function implementation unit
311 processor
312 memory
313 input/output interface
314 communication interface
402 token generation unit
403 database management unit
405 verification information generation unit
407 search unit

What is claimed is:

1. A server device comprising:
at least one processor configured to:
receive an authentication request from a terminal, the terminal having acquired biometric information about a person to be authenticated among a plurality of terminals, the authentication request including biometric information about the person to be authenticated; and
perform biometric authentication using biometric information about the person to be authenticated and biometric information about each of a plurality of users registered in advance; and
a storage unit that stores the biometric information registered in advance and authentication result detailed information in association with each other with respect to, an authentication-successful person who has succeeded in the biometric authentication, the authentication result detailed information including details when the authentication request is processed, the authentication result detailed information including biometric information acquired by a terminal that is a transmission source of the authentication request.

2. The server device according to claim 1, wherein
the authentication result detailed information stored in the storage unit further includes a terminal ID for identifying a transmission source of the authentication request, and
the at least one processor is configured to generate authentication result verification information including at least the biometric information registered in advance, the terminal ID, and biometric information acquired by the terminal.

3. The server device according to claim 2, wherein the authentication result detailed information includes a similarity when it is determined that authentication succeeds by the biometric authentication.

4. The server device according to claim 3, wherein the at least one processor analyzes the authentication result detailed information and determines whether to generate the authentication result verification information.

5. The server device according to claim 4, wherein the at least one processor determines whether to generate the authentication result verification information based on the similarity.

6. The server device according to claim 5, wherein the at least one processor generates the authentication result verification information in a case where a similarity included in the authentication result detailed information is smaller than a first threshold value.

7. The server device according to claim 5, wherein the at least one processor generates the authentication result verification information in a case where a difference between a first similarity having a largest value and a second similarity having a second largest value is smaller than a second threshold value.

8. The server device according to claim 5, wherein
in a case where a plurality of pieces of the authentication result detailed information is stored for a same authentication-successful person,
the at least one processor
determines whether to generate the authentication result detailed information based on a result of a statistical process on time series data having a similarity included in each of the plurality of pieces of authentication result detailed information as an element.

9. The server device according to claim 2, wherein the at least one processor transmits the authentication result verification information to a staff terminal used by a staff member of an airport or an airline.

10. The server device according to claim 9, wherein the at least one processor analyzes the authentication result detailed information periodically or at a predetermined timing and transmits, to the staff terminal, information about a flight of a related authentication-successful person together with the authentication result verification information determined to be required to be generated.

11. The server device according to claim 1, wherein the biometric information is a face image or a feature amount extracted from the face image.

12. A system comprising:
a plurality of terminals; and
a server device according to claim 1, the server device being connected to the plurality of terminals.

13. A method for controlling a server device, the method comprising:
by the server device,
receiving an authentication request from a terminal, the terminal having acquired biometric information about a person to be authenticated among a plurality of terminals, the authentication request including biometric information about the person to be authenticated;
performing biometric authentication using biometric information about the person to be authenticated and biometric information about each of a plurality of users registered in advance; and
storing the biometric information registered in advance and authentication result detailed information in association with each other with respect to an authentication-successful person who has succeeded in the biometric authentication, the authentication result detailed information including details when the authentication request is processed, the authentication result detailed information including biometric information acquired by a terminal that is a transmission source of the authentication request.

14. A non-transitory computer-readable storage medium storing a program for causing a computer mounted on a server device to execute processing comprising:
receiving an authentication request from a terminal, the terminal having acquired biometric information about a person to be authenticated among a plurality of terminals, the authentication request including biometric information about the person to be authenticated;
performing biometric authentication using biometric information about the person to be authenticated and biometric information about each of a plurality of users registered in advance; and
storing the biometric information registered in advance and authentication result detailed information in association with each other with respect to an authentication-successful person who has succeeded in the biometric authentication, the authentication result detailed information including details when the authentication request is processed, the authentication result detailed information including biometric information acquired by a terminal that is a transmission source of the authentication request.
